(19) United States
(12) Patent Application Publication
(10) Pub. No.: US 2018/0255359 A1
(43) Pub. Date: Sep. 6, 2018

(54) METHOD FOR SHARING A CAPTURED VIDEO CLIP AND ELECTRONIC DEVICE

(71) Applicants: LE HOLDINGS (BEIJING) CO., LTD., Beijin (CN); LE SHI INTERNET INFORMATION & TECHNOLOGY CORP., BEIJING, Beijing (CN)

(72) Inventor: Yuanhang REN, BEIJING (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/120,404

(22) PCT Filed: May 27, 2016
(86) PCT No.: PCT/CN2016/083721

§ 371 Date: Aug. 19, 2016

(30) Foreign Application Priority Data
Nov. 25, 2015 (CN) 201510836731.4

(51) Int. Cl. H04N 21/4788; H04N 21/234; H04N 21/232; H04N 21/236

(52) U.S. Cl. CPC H04N 21/4788; H04N 21/236; H04N 21/232; H04N 21/234

(57) ABSTRACT

Disclosed is a method for sharing a video clip and electronic device, the method comprising the steps of after receiving a video sharing trigger instruction, acquiring a playing starting time point and a playing ending time point of a video file to be shared; capturing a video clip from the video file based on the acquired playing start time point and playing end time point to generate a video clip file; and sending the video clip file to a target user.

### CROSS REFERENCE TO RELATED APPLICATIONS

This application is a continuation of International Application No. PCT/CN2016/083721, filed on May 27, 2016, which is based upon and claims priority to Chinese Patent Application No. 2015108367314, filed on Nov. 25, 2015, the entire contents of all of which are incorporated herein by reference.

### TECHNICAL FIELD

The present disclosure relates to media communication technology, in particular to a method for sharing a captured video clip and electronic device.

### BACKGROUND

With development of computer communication, interne and multimedia technology, watching videos has been more widely used. During watching a video, users often meet some video contents of interest to share them with friends.

Currently, there are two ways to share videos: one is to capture an image of the user's current video to share, which just is a static image share; the other is to share the whole video file being watched by the user, in which typically only the link or name of the video can be shared to show other users that the user wants to share the whole video, but the true clip of the user's interest cannot be shared. Thus, it can be seen that both the sharing ways in prior art have a single function and cannot satisfy the various and personal demands of users for video sharing.

### SUMMARY

In view of this, an object of the disclosure is to propose a method for sharing captured video clip and electronic device to address the problem that only a video image at a playing time point of the playing video or the whole video file maybe shared.

Based on the object, an embodiment of the present disclosure provides a method for sharing a captured video clip, as an embodiment including:

at an electronic device;

acquiring a playing starting point and a playing ending time point of a video file to be shared, after receiving a trigger instruction for video sharing;

capturing a video clip from the video file based on the acquired playing start time point and playing end time point to generate a video clip file; and

sending the video clip file to a target user.

Another aspect of embodiments of the present disclosure provides an electronic device, including:

at least one processor(s); and

a memory communicably connected with the at least one processor for storing instructions executable by the at least one processor, wherein execution of the instructions by the at least one processor causes the at least one processor to:

after receiving a video sharing trigger instruction, acquire a playing start time point and a playing end time point of a video file to be shared;

capture a video clip from the video file based on the acquired playing start time point and playing end time point to generate a video clip file; and

send the video clip file to a target user.

A non-transitory computer-readable storage medium storing executable instructions that, when executed by an electronic device, cause the electronic device to:

acquire a playing starting point and a playing ending point of a video file to be shared ,after receiving a trigger instruction for video sharing;

capture a video clip from the video file based on the acquired playing start time point and playing end time point to generate a video clip file; and

send the video clip file to a target user.

### BRIEF DESCRIPTION OF DRAWINGS

The accompanying drawings, which are incorporated in and constitute a part of this specification, illustrate embodiments consistent with the disclosure and, together with the description, serve to explain the principles of the invention

FIG. 1 is a schematic flow diagram of a method for sharing a captured video clip according to some embodiments of the present disclosure;

FIG. 2 is a schematic flow diagram of a method for sharing a captured video clip according to some embodiments of the present disclosure;

FIG. 3 is a schematic view of an apparatus for sharing a captured video clip according to an embodiment of the present disclosure.

### DETAILED DESCRIPTION

The present disclosure is described more fully hereinafter with reference to the accompanying drawings so that the objects, technical solutions and advantages of the present disclosure will become more apparent.

According to the current utilization of multimedia platforms, during watching a video, the user only may share a video image at a playing time or share the whole video file to being watched with friends, which causes a poor user's experience. To solve this problem, the present disclosure started from the user's perspective and found that the user only expects to share a playing period of interest with friends. Thus, the idea of the present disclosure is to establish a video capture function in a multimedia platform and the captured video clips may be shared with friends at the same time.

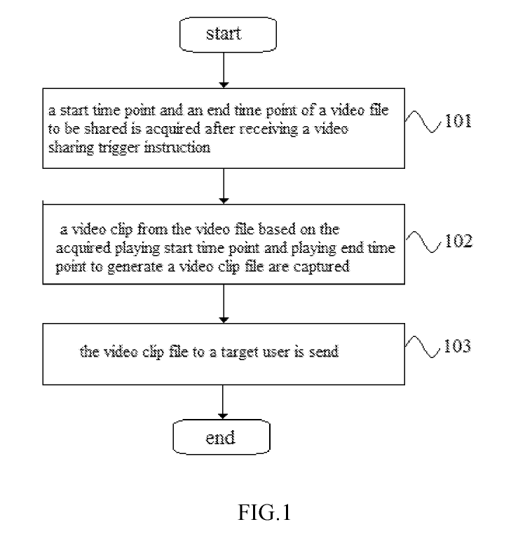

Referring to FIG. 1, it is a schematic flow diagram of a method for sharing a captured video clip according to some embodiments of the present disclosure, the method for sharing a captured video clip including the following steps:

in Step 101, a start time point and an end time point of a video file to be shared is acquired after receiving a video sharing trigger instruction;

As an example, a function button for capturing a video file may be provided in a video file playing page and the function button may be clicked by a mouse. During playback of the video file, a user at client end may interest in a clip of the video and expect to share the clip with friends to watch, at this time, the user may click the function button for capturing a video file in the video file playing page to acquire a video file capturing instruction. In addition, the function button may be arranged in a playback area in the video file playing page or outside the playback area in the video file playing page.

Alternatively, when the user's trigger instruction of capturing a video file is received during playback of the video file, a time point of receiving the trigger instruction for the first time is set to the playing start time point and the time point of receiving the trigger instruction for the second time is set to the playing end time point.

As another alternative embodiment, when the user's trigger instruction of capturing a video file is received during playback of the video file, a current time point is set to a base time point for capturing, and the playing start time point and playing end time point are determined based on a preset capturing manner. In addition, when the user's trigger instruction of capturing a video file is received during playback of the video file, if the current playing time point is not considered as a base time point for capturing, jumping to a video capture edit page in which a video progress bar of the playing video is displayed, and clicking the base time point for capturing on the video progress bar. Alternatively, after the user at client end clicks the function button for capturing a video file in the video file playing page, a dialog box will be ejected and prompt that “whether the video at the current playing time point is captured” for the user to select.

In addition, as another alternative embodiment, it also may be set that when the user at client end left-clicks the function button for capturing a video file on a video playback page by using a mouse, the current playing time point is captured as default. It is also may be set that when the user at client end left-clicks the function button for capturing a video file on a video playback page by using a mouse, a menu of the function button is ejected and the user may select to capture the current playing time point or not.

in step 102, a video clip from the video file based on the acquired playing start time point and playing end time point to generate a video clip file are captured.

In this embodiment, if the user determines to capture the current playing time point, directly capturing the video clip including the current playing time point on the video progress bar; if determines not to capture the current playing time point; clicking the capture base time point on the extracted video progress bar and capturing a video clip including the base time point to be captured on the video progress bar. Alternatively, if the user determines not to capture the current playing time point, jumping to a video capture edit page in which the extracted video progress bar of the current playing video file is played, and clicking arbitrarily at the base time point to be captured on the video progress bar.

Alternatively, before capturing the video clip including the base time point to be captured on the video progress bar, it is determined whether it is captured in the preset capture manner.

The capture manner includes: capturing the video clip by taking the capture base time point as a start time point; or capturing the video clip by taking the capture base time point as an end time point; or capturing a video clip by taking the capture base time point as a middle time point. According to the result of determination, if the video clip is captured in the preset capture manner, directly capturing the video clip including the base time point to be captured on the video progress bar based on the preset capture manner; if the video clip is not captured in the preset capture manner, selecting a capture manner to be used and executing the step of capturing a video clip on the video progress bar.

In addition, according to the result of determination, if the video clip is not captured in the preset capture manner, jumping to the video capture edit page and then clicking at a start time point and an end time point before and after the base time point to be captured on the video progress bar displayed in the video capture edit page.

In step 103, the video clip file to a target user is sent.

In this embodiment, after the user at client end captures a video clip, may select a sharing platform and enter an application of the sharing platform to share the captured video clip with friends. The user also may select a sharing platform and call the API interface of the sharing platform to send the captured video clip to the sharing platform to be shared with friends.

As another alternative embodiment, after the step 102 of capturing a video clip including the base time point to be captured, it may be determined whether multiple video clips are expected to be captured; if the multiple video clips are to be captured, storing the captured video clip and clicking at a new capture base time point on the video progress bar to capture a new video clip including the new capture base time points, and execute the step 103 of sending all the captured video clips to the target user; if the multiple video clips are not to be captured, directly executing the step 103 of sending the captured video clip to the target user. According to the above-described embodiments, it may be seen that the method for sharing a captured video clip may satisfy the user to capture a video clip and share it with friends. At the same time, the method provides a humanization design that the video clips with different contents may be captured, for example, the various determinations and selections of the capture base time points and a plurality of manners to capture the video clips. Therefore, it does not only achieve the capture and share of the video clips, but also provide a large number of alternative implementations.

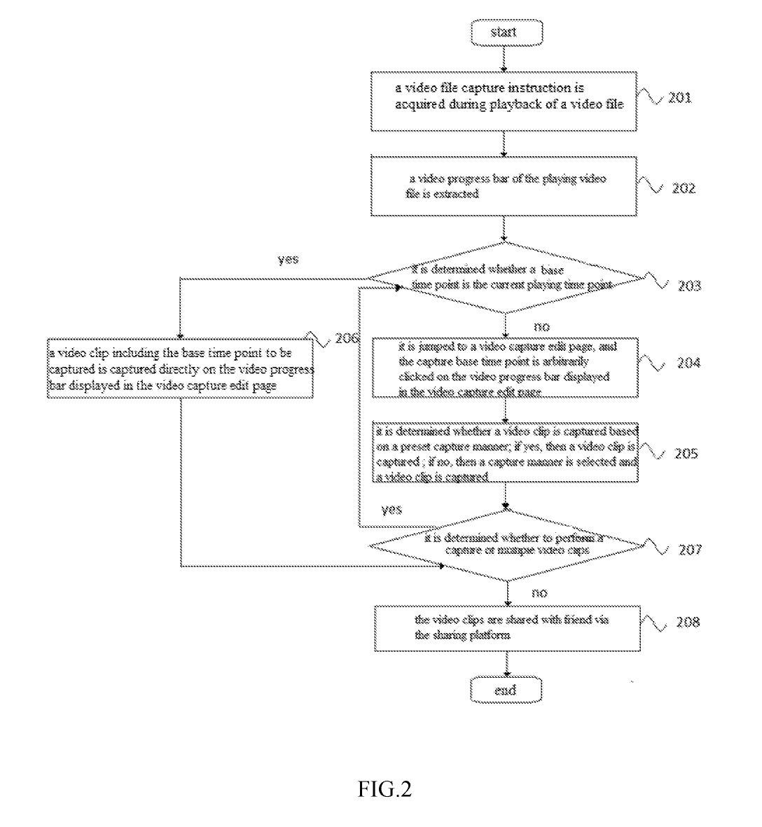

As a referable example, referring to FIG. 2, the method for sharing a captured video clip may employ the following steps:

In step 201, a video file capture instruction is acquired during playback of a video file.

In step 202, a video progress bar of the playing video file is extracted.

In step 203, it is determined whether a base time point to be captured is the current playing time point; if the base time point to be captured is the current playing time point, the step 206 is executed, and then the step 207 is executed; if a base time point to be captured is not the current playing time point, the steps 204 and 205 are executed and then the step 207 is executed.

In step 204, it is jumped to a video capture edit page, and the capture base time point is arbitrarily clicked on the video progress bar displayed in the video capture edit page.

In step 205, it is determined whether a video clip is captured based on a preset capture manner; if the video clip is captured based on a preset capture manner, the video clip including the base time point to be captured is captured on the video progress bar displayed in the video capture edit page, and then the step 207 is executed; if the video clip is not captured based on a preset capture manner, a capture manner is selected and a video clip including the capture base time point is captured on the video progress bar displayed in the video capture edit page based on the selected capture manner, and then the step 207 is executed.

Among them, the capture manner includes: capturing the video clip by taking the capture base time point as a start time point; or capturing the video clip by taking the base time point to be captured as an end time point; or capturing the video clip by taking the base time point to be captured as a middle time point; etc. If the above-mentioned capture manners cannot meet the demand of capturing a video clip, then alternatively, the video capture edit page is jumped to and a start time point and an end time point before and after the base time point to be captured are clicked on the video progress bar displayed in the video capture edit page, and then the step 207 is executed.

In step 206,a video clip including the base time point to be captured is captured directly on the video progress bar displayed in the video capture edit page, and then the step 207 is executed. In step 207, it is determined whether to perform a capture of multiple video clips; if the multiple video clips are to be captured, the captured video clip is stored and the step 203 is returned to; if no, then the step 208 is executed. In step 208, the video clips are shared with friend via the sharing platform.

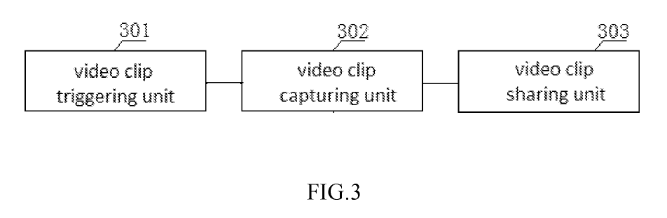

In another aspect of embodiments of the present invention, it is also provided an apparatus for sharing a captured video clip, as shown in FIG. 3, the apparatus for sharing a captured video clip including a video clip triggering unit 301, a video clip capturing unit 302 and a video clip sharing unit 303, wherein the video clip triggering unit 301 is used for after receiving a video sharing trigger instruction, acquiring a playing start time point and a playing end time point of a video file to be shared; the video clip capturing unit 302 is used for capturing a video clip from the video file based on the acquired playing start time point and playing end time point to generate a video clip file; and the video clip sharing unit 303 is used for sending the video clip file to a target user.

Alternatively, the step of the video clip capturing unit 302 acquiring a playing start time point and a playing end time point of a video file to be shared includes the steps of during playback of a video file, receiving a video clip capture trigger instruction by a user; and setting the time point of receiving the trigger instruction for the first time to the playing start time point and setting the time point of receiving the trigger instruction for the second time to the playing end time point; or during playback of a video file, receiving a video clip capture trigger instruction by a user; and taking the current time as a capture base time point to determine the playing start time point and the playing end time point based on a preset capturing manner.

As another example of the present invention, the video clip capturing unit 302 determines whether the base time point to be captured is a current playing time point; if result of the determination is yes, directly capturing a video clip containing the current playing time point on the extracted video progress bar; if result of the determination is no, clicking the capture base time point on the extracted video progress bar and then capturing a video clip containing the capture base time point on the extracted video progress bar. Alternatively, if result of the determination is that the current playing time is not captured, then jumping to a video capture edit page in which a video progress bar of the playing video is displayed, and arbitrarily clicking the capture base time point on the video progress bar.

Alternatively, before the video clip including the base time point is captured on to be captured the video progress bar, it is determined whether it is captured based on the preset capture manner; if the video clip is captured in the preset capture manner, directly capturing the video clip including the base time point to be captured on the video progress bar based on the preset capture manner; if the video clip is not captured in the preset capture manner, selecting a capture manner or jumping to the video capture edit page to capture a video clip including the base time point to be captured on the video progress bar again; wherein the capture manner includes: capturing a video clip by taking the capture base time point as a start time point; or capturing a video clip by taking the base time point to be captured as an end time point; or capturing a video clip by taking the base time point to be captured as a middle time point.

Further, according to the result of determination, if the video clip is not captured in the preset capture manner, the video capture edit page may be jumped to and then a start time point and an end time point before and after the base time point to be captured are clicked on the video progress bar displayed in the video capture edit page.

As another referable example, after the video clip capturing unit 302 captures a video clip including the base time point to be captured on the video progress bar, it may be determined whether multiple video clips are captured; if the multiple video clips are to be captured, storing the captured video clip, clicking a new capture base time point on the video progress bar to capture a new video clip including the new capture base time point on the video progress bar, and the video clip capturing unit 302 being communicated with the video clip sharing unit 303; if the multiple video clips are not to be captured, the video clip capturing unit 302 being directly communicated with the video clip sharing unit 303.

It should be noted that the specific contents of the apparatus for sharing a video clip has been described in the above-described method for sharing a video clip in detail, so that the repeat contents will be not described herein.

Another aspect of embodiments of the present disclosure provides a device, including:

one or more processor(s); and

a memory for storing an operating instruction;

wherein the one or more processor(s) is/are configured to acquire the operation instruction from the memory to execute the steps of:

acquiring a playing starting time point and a playing ending time point of a video file to be shared, after receiving a trigger instruction for video sharing;

capturing a video clip from the video file based on the acquired playing start time point and playing end time point to generate a video clip file; and

sending the video clip file to a target user.

Alternatively, the processor is used for executing of the acquiring a playing start time point and a playing end time point of a video file to be shared, including:

setting a time point of receiving the trigger instruction for the first time as to the playing start time point and setting the time point of receiving the trigger instruction for the second time as to the playing end time point; or

using a current time as a base time point to be captured, and determining the playing start time point and the playing end time point based on a preset capturing manner.

Further, the processor is used for executing of the acquiring a playing start time point and a playing end time point of a video file to be shared, including:

if the current time of a displaying video is not set as the base time point for capturing, jumping to a video capture edit page in which a video progress bar of the playing video is displayed, and clicking on the video progress bar to set the base time point for capturing.

Further, the processor is used for executing:

before capturing a video clip including the base time point to be captured on the video progress bar,

determining whether the video clip is captured in the preset capture manner; if the video clip is captured in the preset capture manner, directly capturing the video clip including the base time point to be captured on the video progress bar based on the preset capture manner; if the video clip is not captured in the preset capture manner, selecting a capture manner to be used or jumping to the video capture edit page to capture the video clip including the base time point to be captured on the video progress bar;

wherein the capture manner includes: capturing the video clip by taking the capture base time point as a start time point; or capturing the video clip by taking the capture base time point as an end time point; or capturing the video clip by taking the capture base time point as a middle time point.

Further, the processor is used for executing:

after capturing a video clip containing the capture base time point on the video progress bar,

determining whether multiple video clips are to be captured; if the multiple video clips are to be captured, storing the captured video clip file, clicking new base time points to be captured on the video progress bar to capture new video clips including the new capture base time points, and sending all the captured video clip files to the target user; if the multiple video clips are not to be captured, directly sending the captured video clip file to the target user.

In a word, the method for sharing a video clip and electronic device of the preset disclosure has creatively addressed the problem of uniqueness of media share service to achieve the diversity of the share service, so that the shared video content may be more targeted and personal. Finally, whole method for sharing a video clip and electronic device are simple, compact and easy to implement.

In addition, typically, the apparatus or terminal device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and apparatus units can also be implemented by using a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As a example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct Ram bus RAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, and removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present invention, and there are many other variations of the different aspects of the present disclosure as described herein without description in the details for simplicity. Thus, any omissions, modifications, equivalent replacements and improvements made in the spirit and principles of the present disclosure should be included within the scopes of the present invention.

What is claimed is:

1. A method for sharing a captured video clip, comprising:
at an electronic device;
acquiring a playing starting point and a playing ending point of a video file to be shared, after receiving a trigger instruction for video sharing;
capturing a video clip from the video file based on the acquired playing start time point and playing end time point to generate a video clip file; and
sending the video clip file to a target user.

2. The method according to claim 1, wherein the acquiring a playing start time point and a playing end time point of a video file to be shared comprises:
setting a time point of receiving the trigger instruction for the first time as the playing start time point and setting the time point of receiving the trigger instruction for the second time as the playing end time point; or
using a current time as a base time point to be captured, and determining the playing start time point and the playing end time point based on a preset capturing manner.

3. The method according to claim 2, wherein the acquiring a playing start time point and a playing end time point of a video file to be shared further comprises:
if the current time of a displaying video is not set as the base time point for capturing, jumping to a video capture edit page in which a video progress bar of the playing video is displayed, and clicking on the video progress bar to set the base time point for capturing.

4. The method according to claim 3, wherein before capturing a video clip containing the capture base time point on the video progress bar, the method further comprises:
determining whether the video clip is captured in the preset capture manner; if the video clip is captured in the preset capture manner, directly capturing the video clip including the base time point to be captured on the video progress bar based on the preset capture manner; if the video clip is not captured in the preset capture manner, selecting a capture manner to be used or jumping to the video capture edit page to capture the video clip including the base time point to be captured on the video progress bar;
wherein the capture manner includes: capturing the video clip by taking the capture base time point as a start time point; or capturing the video clip by taking the capture base time point as an end time point; or capturing the video clip by taking the capture base time point as a middle time point.

5. The method according to claim 4, wherein after capturing a video clip containing the capture base time point on the video progress bar, the method further comprises:
determining whether multiple video clips are to be captured; if the multiple video clips are to be captured, storing the captured video clip file, clicking new base time points to be captured on the video progress bar to capture new video clips including the new capture base time points, and sending all the captured video clip files to the target user; if the multiple video clips are not to be captured, directly sending the captured video clip file to the target user.

6. An electronic device, comprising:
at least one processor(s); and
a memory communicably connected with the at least one processor for storing instructions executable by the at least one processor, wherein execution of the instructions by the at least one processor causes the at least one processor to:
after receiving a video sharing trigger instruction, acquire a playing start time point and a playing end time point of a video file to be shared;
capture a video clip from the video file based on the acquired playing start time point and playing end time point to generate a video clip file; and
send the video clip file to a target user.

7. The device according to claim 6, wherein the step to acquire a playing start time point and a playing end time point of a video file to be shared comprises:
setting a time point of receiving the trigger instruction for the first time as the playing start time point and setting the time point of receiving the trigger instruction for the second time as the playing end time point; or
using a current time as a base time point to be captured, and determining the playing start time point and the playing end time point based on a preset capturing manner.

8. The device according to claim 7, wherein the step of acquiring a playing starting point and a playing ending point of a video file to be shared, comprising:
if the current time of a displaying video is not set as the base time point for capturing, jumping to a video capture edit page in which a video progress bar of the playing video is displayed, and clicking on the video progress bar to set the base time point for capturing.

9. The device according to claim 8, wherein before capturing a video clip containing the capture base time point on the video progress bar, the processor is further caused to:
determine whether the video clip is captured in the preset capture manner; if the video clip is captured in the preset capture manner, directly capturing the video clip including the base time point to be captured on the video progress bar based on the preset capture manner; if the video clip is not captured in the preset capture manner, selecting a capture manner to be used or jumping to the video capture edit page to capture the video clip including the base time point to be captured on the video progress bar;
wherein the capture manner includes: capturing the video clip by taking the capture base time point as a start time point; or capturing the video clip by taking the capture base time point as an end time point; or capturing the video clip by taking the capture base time point as a middle time point.

10. The device according to claim 9, wherein the processor is further caused to:
after capturing a video clip containing the capture base time point on the video progress bar,
determine whether multiple video clips are to be captured; if the multiple video clips are to be captured, store the captured video clip file, click new base time points to be captured on the video progress bar to capture new video clips including the new capture base time points, and send all the captured video clip files to the target user; if the multiple video clips are not to be captured, directly send the captured video clip file to the target user.

11. Anon-transitory computer-readable storage medium storing executable instructions that, when executed by an electronic device, cause the electronic device to:
acquire a playing starting point and a playing ending point of a video file to be shared, after receiving a trigger instruction for video sharing;
capture a video clip from the video file based on the acquired playing start time point and playing end time point to generate a video clip file; and
send the video clip file to a target user.

12. The non-transitory computer-readable storage medium according to claim 11, wherein the step to acquire a playing start time point and a playing end time point of a video file to be shared comprises:
setting a time point of receiving the trigger instruction for the first time as the playing start time point and setting the time point of receiving the trigger instruction for the second time as the playing end time point; or
using a current time as a base time point to be captured, and determining the playing start time point and the playing end time point based on a preset capturing manner.

13. The non-transitory computer-readable storage medium according to claim 12, wherein the acquiring a playing start time point and a playing end time point of a video file to be shared, comprising:
if the current time of a displaying video is not set as the base time point for capturing, jumping to a video capture edit page in which a video progress bar of the playing video is displayed, and clicking on the video progress bar to set the base time point for capturing.

14. The non-transitory computer-readable storage medium according to claim 13, wherein before capturing a video clip containing the capture base time point on the video progress bar, the processor is further caused to:
determine whether the video clip is captured in the preset capture manner; if the video clip is captured in the preset capture manner, directly capturing the video clip including the base time point to be captured on the video progress bar based on the preset capture manner; if the video clip is not captured in the preset capture manner, selecting a capture manner to be used or jumping to the video capture edit page to capture the video clip including the base time point to be captured on the video progress bar;
wherein the capture manner includes: capturing the video clip by taking the capture base time point as a start time point; or capturing the video clip by taking the capture base time point as an end time point; or capturing the video clip by taking the capture base time point as a middle time point.

15. The non-transitory computer-readable storage medium according to claim 14, wherein the processor is further caused to:
after capturing a video clip containing the capture base time point on the video progress bar,
determine whether multiple video clips are to be captured; if the multiple video clips are to be captured, store the captured video clip file, clicking new base time points to be captured on the video progress bar to capture new video clips include the new capture base time points, and send all the captured video clip files to the target user; if the multiple video clips are not to be captured, directly send the captured video clip file to the target user.
